(19) United States
(12) Patent Application Publication
(10) Pub. No.: US 2007/0149392 A1
(43) Pub. Date: Jun. 28, 2007

(54) Reactor for carbon dioxide capture and conversion

(76) Inventors: Anthony Yu-Chung Ku, Rexford, NY (US); James Anthony Ruud, Delmar, NY (US); Mohan Manoharan, Niskayuna, NY (US); Lawrence Bernard Kool, Clifton Park, NY (US); Sergio Paulo Martins-Loureiro, Saratoga Springs, NY (US); Margaret Louise Blohm, Niskayuna, NY (US); Bruce Gordon Norman, Burnt Hills, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/317,138

(22) Filed: Dec. 22, 2005

(51) Int. Cl. B01J 23/00; B01D 53/94

(52) U.S. Cl. 502/240; 502/300; 423/220

(57) ABSTRACT

Disclosed herein is a multifunctional catalyst system comprising a substrate; and a catalyst pair disposed upon the substrate; wherein the catalyst pair comprises a first catalyst and a second catalyst; and wherein the first catalyst initiates or facilitates the reduction of carbon dioxide to carbon monoxide while the second catalyst initiates or facilitates the conversion of carbon monoxide to an organic compound. Disclosed herein is a method comprising reducing carbon dioxide to carbon monoxide in a first reaction catalyzed by a first catalyst; and reacting carbon monoxide with hydrogen in a second reaction catalyzed by second catalyst; wherein the first catalyst and the second catalyst are disposed upon a single substrate.

### BACKGROUND

This disclosure relates to a reactor for carbon dioxide capture and conversion.

Fossil fuel combustion has been identified as a significant contributor to numerous adverse environmental effects. For example, poor local air quality, regional acidification of rainfall that extends into lakes and rivers, and a global increase in atmospheric concentrations of greenhouse gases (GHG), have all been associated with the combustion of fossil fuels. In particular, increased concentrations of GHG's are a significant concern since the increased concentrations may cause a change in global temperature, thereby potentially contributing to global climatic disruption. Further, GHG's may remain in the earth's atmosphere for up to several hundred years.

One problem associated with the use of fossil fuel is that the consumption of fossil fuel correlates closely with economic and population growth. Therefore, as economies and populations continue to increase worldwide, substantial increases in the concentration of GHG's in the atmosphere is expected. In order to reduce the amount of GHG's it is desirable to have technologies that facilitate the separation and/or the conversion of carbon dioxide into a form that does not contribute to the greenhouse effect.

### SUMMARY

Disclosed herein is a multifunctional catalyst system comprising a substrate; and a catalyst pair disposed upon the substrate; wherein the catalyst pair comprises a first catalyst and a second catalyst; and wherein the first catalyst initiates or facilitates the reduction of carbon dioxide to carbon monoxide while the second catalyst initiates or facilitates the conversion of carbon monoxide to an organic compound.

Disclosed herein is a method comprising reducing carbon dioxide to carbon monoxide in a first reaction catalyzed by a first catalyst; and reacting carbon monoxide with hydrogen in a second reaction catalyzed by second catalyst; wherein the first catalyst and the second catalyst are disposed upon a single substrate.

Disclosed herein is a process comprising selectively functionalizing a substrate to form a functionalized substrate; reacting a reverse water gas shift reaction catalyst to a first region of the functionalized substrate; and reacting a Fischer-Tropsch catalyst to a second region of the functionalized substrate; wherein an average particle or domain spacing between particles or domains comprising the reverse water gas shift reaction catalyst or the Fischer-Tropsch catalyst is about 10 to about 1,000 nanometers.

### DETAILED DESCRIPTION OF FIGURES

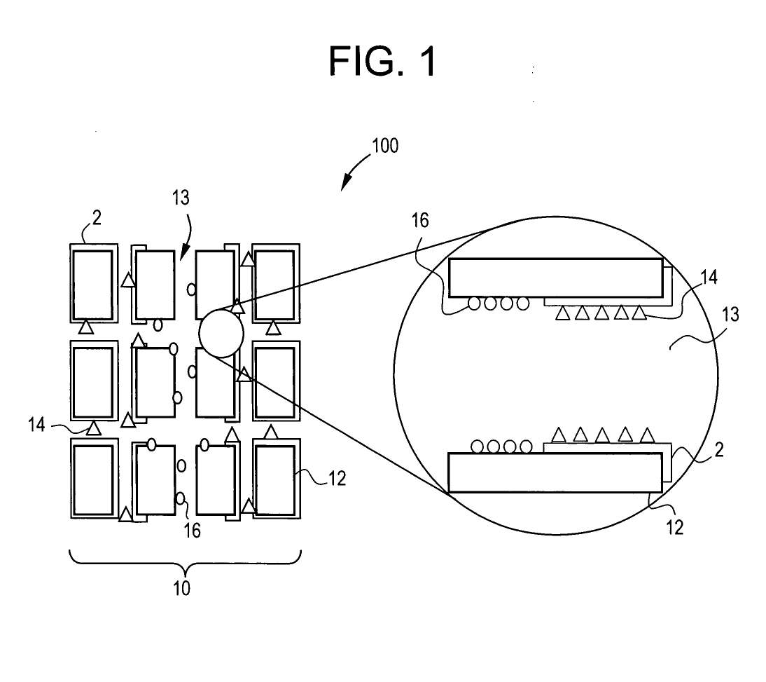

FIG. 1 is an exemplary schematic that depicts one embodiment of the structure of a multifunctional catalyst system; and

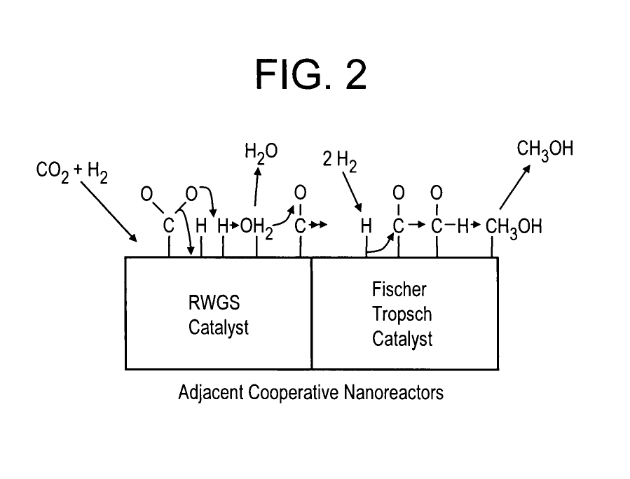

FIG. 2 is an exemplary schematic depicting a substrate upon which a reverse water gas shift reaction catalyst is disposed adjacent to a Fischer-Tropsch catalyst.

### DETAILED DESCRIPTION

It is to be noted that the terms “first,” “second,” and the like as used herein do not denote any order, quantity, or importance, but rather are used to distinguish one element from another. The terms “a” and “an” do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). It is to be noted that all ranges disclosed within this specification are inclusive and are independently combinable. The term “and/or” as used herein implies either or both. For example, if it is stated that A and/or B can be used, then it implies that A, B or both A and B can be used.

Furthermore, in describing the arrangement of components in embodiments of the present disclosure, the terms “upstream” and “downstream” are used. These terms have their ordinary meaning. For example, an “upstream” device as used herein refers to a device producing a fluid output stream that is fed to a “downstream” device. Moreover, the “downstream” device is the device receiving the output from the “upstream” device. However, it will be apparent to those skilled in the art that a device may be both “upstream” and “downstream” of the same device in certain configurations, e.g., a system comprising a recycle loop.

Disclosed herein is a multifunctional catalyst system that extracts carbon dioxide from a gas stream and converts it to a product that does not comprise carbon dioxide. The multifunctional catalyst system can thus advantageously be used for reducing carbon dioxide emissions into the atmosphere. In an exemplary embodiment, the multifunctional catalyst system facilitates the simultaneous conduction of multiple reactions in series or parallel. The products that do not contain carbon dioxide are organic molecules. In one embodiment, the hydrocarbons are saturated hydrocarbons and/or unsaturated hydrocarbons. Examples of organic molecules are paraffins, olefins, oxygenates, or the like, or a combination comprising at least one of the foregoing organic molecules.

In a first embodiment, carbon dioxide that is transferred into the multifunctional catalyst system reacts with a reactant located in the multifunctional catalyst system to produce a fluid product that does not comprise carbon dioxide. The fluid product is then transferred out of the multifunctional catalyst system. The term “located” as used herein in connection with the reactant means that the reactant is bonded to a chemical structure present in the multifunctional catalyst system.

In a second embodiment, carbon dioxide that is transferred into the multifunctional catalyst system is converted into a reduced form of carbon by reacting with a first reactant that is also transferred into the multifunctional catalyst system. The reduced form of carbon is reacted with a second reactant to produce a product that does not comprise carbon dioxide. In both of the foregoing embodiments, energy may be introduced into the multifunctional catalyst system to facilitate the conversion of carbon dioxide. The multifunctional catalyst system can also comprise catalysts to initiate a given reaction and/or to cause the reaction to proceed under different conditions than are otherwise possible.

In an exemplary embodiment, the multifunctional catalyst system can be functionalized to facilitate the conduction of a reverse water gas shift reaction in series with a Fischer-Tropsch reaction. The reverse water gas shift reaction generally reduces carbon dioxide to carbon monoxide, while the carbon dioxide produced in the reverse water gas shift reaction is converted to hydrocarbons such as, for example, ethylene (C₂H₄) using a Fischer-Tropsch reaction. The term “functionalized” as defined herein means that the multifunctional catalyst system is provided with reactive species and/or catalysts that facilitate the conversion of carbon dioxide to a product that does not comprise carbon dioxide.

The multifunctional catalyst system generally comprises a substrate upon which is disposed a plurality of catalysts that can facilitate the reverse water gas shift reaction and the Fischer-Tropsch reaction. The term “plurality of catalysts” is intended to mean “two or more” and as used herein implies “types of particles” or “composition of particles” rather than the number of particles. The term has the same meaning as the term “plurality of catalyst particles”.

The substrate can be a ceramic substrate, a fibrous substrate, or the like. It is desirable for the substrate to be porous. An exemplary substrate is a porous ceramic substrate.

The porous ceramic substrate generally comprises a porous substrate where catalytic particles are selectively located in order to enhance the conversion of carbon dioxide to hydrocarbons. The catalytic particles are generally embedded in the pores. In one embodiment, the composition of the pores and the walls of the substrate can be designed to control chemical stability, catalytic activity and/or surface energy. In another embodiment, the pore architecture of the substrate can be designed to control the diffusion of reactants to the catalyst particles, the permselectivity as well as the surface area of the catalyst particles that are exposed to the reactants.

In one embodiment, the pores of the substrate can have average pores sizes in the nanometer range. Controlling pore sizes and architecture (shape of the pores) of the substrate can facilitate control of the diffusion properties of the multifunctional catalyst system. The pore sizes and architecture can be used to control the transfer of reactants to the catalyst particles, the transfer of products away from the catalyst particles, the rate of heat build up and dissipation in the multifunctional catalyst system.

As noted above, the structure and size of the substrate pores can be used to control diffusion properties and the heat transfer of the multifunctional catalyst system. In one embodiment, the ceramic substrate can comprise inorganic oxides, inorganic carbides, inorganic nitrides, inorganic hydroxides, inorganic oxides having hydroxide coatings, inorganic carbonitrides, inorganic oxynitrides, inorganic borides, inorganic borocarbides, or the like, or a combination comprising at least one of the foregoing inorganic materials. In another embodiment, the ceramic substrate can comprise metal oxides, metal carbides, metal nitrides, metal hydroxides, metal oxides having hydroxide coatings, metal carbonitrides, metal oxynitrides, metal borides, metal borocarbides, or the like, or a combination comprising at least one of the foregoing inorganic materials.

With reference now to the FIG. 1, a multifunctional catalyst system 100 comprises a substrate 10 that comprises walls 12 and pores 14. A first catalyst 14 and a second catalyst 16 are disposed upon the substrate 10. In one embodiment, the first catalyst 14 is a reverse water gas shift reaction catalyst while the second catalyst 16 is a catalyst that facilitates the Fischer-Tropsch reaction.

Examples of suitable inorganic oxides for use in the substrate walls 12 include silica (SiO₂), alumina (Al₂O₃), titania (TiO₂), zirconia (ZrO₂), ceria (CeO₂), zinc oxide (ZnO), iron oxides (e.g., FeO, α-Fe₂O₃, γ-Fe₂O₃, Fe₃O₄, or the like), calcium oxide (CaO), manganese dioxide (MnO₂ and Mn₃O₄), niobium oxide (Nb₂O₃), tantalum pentoxide (Ta₂O₅), tungsten trioxide (WO₃), tin oxide (SnO₂), hafnium oxide (HfO₂), silicon aluminum oxide (SiAlO₃), silicon titanate (SiTiO₄), zirconium titanate (ZrTiO₄), aluminum titanate (Al₂TiO₅), zirconium tungstate (ZrW₂O₈), yttria stabilized zirconia (YSZ), yttrium oxide (Y₂O₃) or a combination comprising at least one of the foregoing inorganic oxides. Examples of suitable synthetically created inorganic carbides include silicon carbide (SiC), titanium carbide (TiC), tantalum carbide (TaC), tungsten carbide (WC), hafnium carbide (HfC), or the like, or a combination comprising at least one of the foregoing carbides. Examples of suitable synthetically created nitrides include silicon nitrides (Si₃N₄), titanium nitride (TiN), or the like, or a combination comprising at least one of the foregoing. Examples of suitable borides are lanthanum boride (LaB₆), titanium boride (TiB₂), zirconium boride (ZrB₂), tungsten boride (W₂B₅), or the like, or combinations comprising at least one of the foregoing borides.

Exemplary substrates 10 are those having walls 12 that comprise silica (SiO₂), titanium dioxide (TiO₂), zirconium dioxide (ZrO₂), alumina (Al₂O₃), or the like, or a combination comprising at least one of the foregoing. In one embodiment, the porous substrate can have pores or channels that are in a lamellar arrangement. A first product obtained as a result of catalysis from the first catalyst 14 disposed in one set of pores can be directed to another set of pores that comprise the second catalyst. The first product is then catalyzed by the second catalyst to form a product that does not contain carbon dioxide.

In one embodiment, the substrate 10 is porous having a porosity of about 10 to about 98 volume percent based on the total volume of the substrate. In another embodiment, the substrate 10 has a porosity of about 25 to about 95 volume percent based on the total volume of the substrate. In yet another embodiment, the substrate 10 has a porosity of about 35 to about 90 volume percent based on the total volume of the substrate. An exemplary porosity is about 50 to about 80 volume percent based on the total volume of the substrate.

The substrates generally have high surface areas of about 1 to about 1000 square meter/gram (m²/g). A high surface area as a result of nano-sized pores enhances catalytic activity. Within this range it is generally desirable for the substrate to have a surface area greater than or equal to about 5 m²/g, specifically greater than or equal to about 10 m²/g, and more specifically greater than or equal to about 15 m²/g. Also desirable within this range is a surface area less than or equal to about 950 m²/g, specifically less than or equal to about 900 m²/g, and more specifically less than or equal to about 875 m²/g.

The average pore sizes for the pores 14 of the substrate can be about 2 to about 50 nanometers. The pore size refers to the size of the diameter of the pore 14. Within this range it is generally desirable for the average pore sizes to be greater than or equal to about 5, specifically greater than or equal to about 10, and more specifically greater than or equal to about 15 nanometers. Also desirable within this range are pore sizes of less than or equal to about 45, specifically less than or equal to about 40, and more specifically less than or equal to about 35 nanometers in diameter. An exemplary average pore size is about 2 to about 15 nanometers. The porous substrate can be monolithic or can be in particle form.

Having pores in the nanometer range permits the catalyst particles to remain in close proximity to each other. This is displayed in the enclosed circle in the FIG. 1. As noted above, the distance between the catalyst particles is chosen to permit the efficient heat and mass transfer during the reactions. From the enclosed circle it may be seen that the first catalyst particles 14 and the second catalyst particles 16 are in close proximity to each other, which permits the reaction product of a first catalyzed reaction to be easily consumed in a second catalyzed reaction. Similarly, the inter-particle spacing can be chosen to facilitate dissipation or utilization of heat generated during the respective reactions.

The average interparticle spacing between the first catalyst and the second catalyst (or regions comprising the first catalyst and regions comprising the second catalyst) is about 10 to about 1,000 nanometers. In one embodiment, the average interparticle spacing between the first catalyst and the second catalyst is about 20 to about 500 nanometers. In another embodiment, the average interparticle spacing between the first catalyst and the second catalyst is about 30 to about 300 nanometers. In yet another embodiment, the average interparticle spacing between the first catalyst and the second catalyst is about 40 to about 100 nanometers.

Commercially available examples of nanosized metal oxides are NANOACTIVET™ calcium oxide, NANOACTIVET™ calcium oxide plus, NANOACTIVET™ cerium oxide, NANOACTIVET™ magnesium oxide, NANOACTIVET™ magnesium oxide plus, NANOACTIVET™ titanium oxide, NANOACTIVET™ zinc oxide, NANOACTIVET™ silicon oxide, NANOACTIVET™ copper oxide, NANOACTIVET™ aluminum oxide, NANOACTIVET™ aluminum oxide plus, all commercially available from NanoScale Materials Incorporated. Commercially available examples of nanosized metal carbides are titanium carbonitride, silicon carbide, silicon carbide-silicon nitride, and tungsten carbide all commercially available from Pred Materials International Incorporated.

In one embodiment, the reverse water gas shift reaction catalyst 14 generally comprises lead oxide (PbO), copper oxide (CuO) and/or zinc oxide (ZnO) disposed upon an alumina (Al₂O₃) substrate. In another embodiment, the reverse water gas shift reaction catalyst 14 comprises platinum disposed upon ceria (CeO₂).

The Fischer-Tropsch catalyst 16 generally comprises Group VIII metals disposed upon silica (SiO₂). Examples of suitable Group VIII metals are iron, cobalt, nickel, or the like, or a combination comprising at least one of the foregoing Group VIII metals.

As noted above, it is desirable to have the reverse water gas shift reaction catalyst 14 disposed at different regions from the Fischer-Tropsch catalyst 16. In one embodiment, the substrate can be treated to have regions of differing selectivity or functionality in order to accommodate the reverse water gas shift reaction catalyst 14 and the Fischer-Tropsch catalyst 16. By separating the reverse water gas shift reaction catalyst 14 and the Fischer-Tropsch catalyst 16 on the substrate the reactions can be made to progress in series without any catalyst poisoning.

In one embodiment, in one manner of disposing the catalysts on the substrate in a manner such that they are spaced at distances of about 10 to about 1,000 nanometers apart, it is desirable to functionalize regions of the substrate to be hydrophobic while certain other regions of the substrate are functionalized to be hydrophobic. By first functionalizing regions of the substrate to be either hydrophobic or hydrophilic, the reverse water gas shift reaction catalyst 14 and the Fischer-Tropsch catalyst 16 can be disposed at different and exclusive regions on the substrate. In one embodiment, a first region of the substrate can be functionalized to accept the reverse water gas shift reaction catalyst 14, while a second region of the substrate can be functionalized to accept the Fischer-Tropsch catalyst 16.

With reference now again to the FIG. 1, a reactive coating 2 is applied to the substrate 10 to transform the chemical character of those portions of the walls 12 to which it is applied. The surface functionalization of the walls 12 of the substrate 10 can be used to selectively bond certain desired catalysts to the walls 12. In one embodiment, by applying a reactive coating to the walls 12, the chemical character of the walls is transformed from hydrophilic to hydrophobic or vice versa. In one embodiment, the wall can be transformed into a hydrophobic surface by the reaction of an alkylsilane to the walls 12.

In one embodiment, in one manner of functioning, the multifunctional catalyst system can be used to reduce carbon dioxide in a first reaction. In one embodiment, the first reaction is a reverse water gas shift reaction as shown in the reaction (I) below:

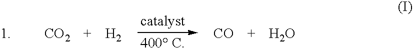

where the reaction (I) is conducted at a temperature of about 400° C. in the presence of a catalyst. As noted above, the catalyst generally comprises lead oxide (PbO), copper oxide (CuO) and/or zinc oxide (ZnO) disposed upon an alumina (Al₂O₃) substrate. The reaction is exothermic and generates heat at a rate of 9 kilocalories per mole.

As can be seen above, the reverse water gas shift reaction is generally conducted at a temperature of about 400° C. The Fischer Tropsch reaction described below is generally conducted at a temperature of about 180 to about 250° C. This disparity in temperature ranges between the temperature of reverse water gas shift reaction catalyst and the temperature of the Fischer Tropsch reaction can produce reaction conditions that are not effectively optimized for sustained maximum production of the organic molecules.

In one embodiment, in order to optimize the reaction conditions it is desirable to select a catalyst that facilitates the reverse water gas shift reaction to be conducted at a temperature that is similar to the temperature at which the Fischer Tropsch reaction is conducted. Such a reverse water gas shift reaction catalyst is termed a low temperature reverse water gas shift reaction catalyst. It is generally desirable for the low temperature reverse water gas shift reaction catalyst to initiate and/or facilitate a reaction that can be conducted at a temperature of about 150 to about 275° C. In one embodiment, it is desirable for the low temperature reverse water gas shift reaction catalyst to initiate and/or facilitate a reaction that can be conducted at a temperature of about 180 to about 250° C.

Examples of the low temperature reverse water gas shift reaction catalysts are gold nanoparticles deposited on crystalline or semi-crystalline metal oxides. The metal oxides can be iron oxide (Fe₂O₃), zirconia (ZrO₂), titania (TiO₂), zinc oxide (ZnO), or a combination comprising at least one of the foregoing. Examples of combinations are a mixture of iron oxide and zinc oxide or a mixture of iron oxide and zinc oxide. These catalysts can initiate and/or facilitate the reverse water gas shift reaction in the temperature range of about 130 to about 260° C. The term semi-crystalline as used herein in reference to the catalysts refers to a mixture of a crystalline phase and an amorphous phase of a given oxide or a combination of oxides. For example, the mixture of iron oxide and zinc oxide can be crystalline or semi-crystalline. In one embodiment, both the iron oxide and the zinc oxide can be semi-crystalline. In another embodiment, the iron oxide can be crystalline while the zinc oxide can be amorphous.

The gold nanoparticles generally have an average particle size of less than or equal to about 10 nanometers. In one embodiment, the average particle size of the gold nanoparticles is generally less than or equal to about 5 nanometers. In another embodiment, the average particle size of the gold nanoparticles is generally less than or equal to about 3 nanometers. The atomic ratio of the gold to the metal (i.e., the metal of the metal oxide) is about 1:20 to about 1:30. An exemplary atomic ratio of the gold to the metal is about 1:22 to about 1:26.

Another example of low temperature reverse water gas shift reaction catalysts are copper and nickel containing cerium oxide catalysts. The copper and nickel are present in nano-crystalline form and are disposed upon the cerium oxide. Nano-crystalline form as used herein implies that the crystals have at least one dimension that is less than or equal to about 1,000 nanometers. In one embodiment, the nano-crystals may have an average size of less than or equal to about 500 nanometers. Lanthanum may be used in an amount of up to 10 wt % (of the total weight of the catalyst) as a structural stabilizer for the ceria. Copper and nickel are used in an amount of about 2 to about 8 wt %. These catalysts are active to initiate or facilitate the reverse water gas shift reaction at a temperature of about 175 to about 300° C.

The carbon monoxide generated in the reaction (I) is then used a second reaction to produce the product that does not contain carbon dioxide. In one embodiment, the second reaction is a Fischer-Tropsch reaction that involves the conversion to an organic molecule as shown in the reaction (II). As noted above, the organic molecule can be a paraffin, an olefin, an alcohol, or the like, or a combination comprising at least one of the foregoing hydrocarbons. The reaction (II) depicts a conversion to ethylene. 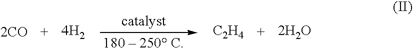
where the reaction (II) is conducted at a temperature of about 180 to about 250° C. in the presence of a catalyst. The reaction (II) is endothermic and can absorb heat generated in the reaction (I). As noted above, the catalyst generally comprises Group VIII metals disposed upon silica (SiO2).

Reactions (I) and (II) can be combined to demonstrate the conversion of carbon dioxide into a olefin as follows in reaction (III) below:
2CO+6H₂→C₂H₄+4H₂ (III)
where the olefin produced is ethylene.

In another embodiment, instead of producing an olefin, the reaction between carbon monoxide and hydrogen can also be used to produce an alcohol as shown in reaction (IV): 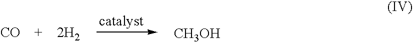
where the alcohol produced in the reaction (IV) is methanol.

Similarly, reactions (I) and (IV) can be combined to demonstrate the conversion of carbon dioxide into alcohol as shown in equation (V) below:
CO+3H₂→CH₃OH+H₂O (V)

Thus the multifunctional catalyst system may be used to conduct sequential reactions to convert carbon dioxide from a waste stream of a given process into a useful product such as olefin or an alcohol.

With reference now to the FIG. 2, in one embodiment, the ceramic substrate 10 may comprise nano-reactors disposed adjacent to each other that can sequentially conduct reactions to convert carbon dioxide into a product that does not contain carbon dioxide. As depicted in the FIG. 2, the substrate 10 comprises a first section 40 upon which is disposed reverse water gas shift reaction catalyst. The substrate 10 further comprises a second section 50 disposed adjacent to the first section 40. The second section 50 comprises a Fischer-Tropsch catalyst that is disposed upon the substrate.

In the reverse water gas shift reaction, carbon dioxide and hydrogen are adsorbed on the active catalyst surface, where there are molecular rearrangements that result in the formation of water and carbon monoxide. As can be seen in the FIG. 2, the products, water and carbon monoxide, are released. Because the reverse water gas shift reaction catalyst is in close proximity to the Fischer-Tropsch catalyst (within about 10 to about 1,000 nanometers) the carbon monoxide can be readily transferred to the Fischer-Tropsch catalyst surface where it is reacted further with hydrogen to form methanol.

In one exemplary embodiment, a catalyst system can be manufactured by functionalizing a porous substrate by treating it with an alkylsilane, which chemically reacts with the surface and renders the pores hydrophobic. The pores can be irradiated with UV light, which degrades the alkyl structure. The porous substrate is then patterned with a combination of ceria and cobalt oxide. These materials have been used as catalysts for reverse water gas shift reactions and Fischer Tropsch reactions respectively.

The membrane is then dipped into an aqueous solution comprising cerium nitrate and then transferred to an organic precursor solution that comprises cobalt 2-ethylhexanoate. The substrate is then dried in air for 30 minutes and calcined at 500° C. for 5 hours to convert the precursor into the final product. The cobalt 2-ethylhexanoate is converted into cobalt oxide. The porous substrate is then treated with an aqueous platinum precursor solution. In one embodiment, the platinum precursor solution can comprise hexachloroplatinic acid (H₂PtCl₆). The pores are then dried and heated in a reducing atmosphere to form cerium oxide with platinum disposed thereon in one region. The cerium oxide with the platinum disposed thereon is the reverse water gas shift reaction catalyst. The other portions of the substrate that do not contain the cerium oxide/platinum are coated with cobalt oxide having platinum disposed thereon. The cobalt oxide with the platinum disposed thereon is the Fischer Tropsch catalyst.

The advantage of this arrangement is that the two different catalysts can be tailored and optimized to perform the specific desired chemical reactions. Their close proximity (on the order of nanometers) enables the rapid shuttling of reactive intermediates between differing active catalytic sites.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A multifunctional catalyst system comprising:
a substrate; and
a catalyst pair disposed upon the substrate; wherein the catalyst pair comprises a first catalyst and a second catalyst; and wherein the first catalyst initiates or facilitates the reduction of carbon dioxide to carbon monoxide while the second catalyst initiates or facilitates the conversion of carbon monoxide to an organic compound.

2. The multifunctional catalyst system of claim 1, wherein the substrate is porous.

3. The multifunctional catalyst system of claim 1, wherein the first catalyst and the second catalyst have an average inter-particle or average inter-domain spacings of about 10 to about 1,000 nanometers.

4. The multifunctional catalyst system of claim 1, wherein the organic compound is an olefin.

5. The multifunctional catalyst system of claim 1, wherein the organic compound is an oxygenate.

6. The multifunctional catalyst system of claim 5, wherein the oxygenate is an alcohol.

7. The multifunctional catalyst system of claim 2, wherein the substrate has a porosity of about 10 to about 90 volume percent based on the total volume of the substrate.

8. The multifunctional catalyst system of claim 1, wherein the substrate comprises inorganic oxides, inorganic carbides, inorganic nitrides, inorganic hydroxides, inorganic oxides having hydroxide coatings, inorganic carbonitrides, inorganic oxynitrides, inorganic borides, inorganic borocarbides, or a combination comprising at least one of the foregoing inorganic materials.

9. The multifunctional catalyst system of claim 1, wherein the substrate comprises a metal oxide, and wherein the metal oxide is alumina, silica, zirconia, titania, ceria, or a combination comprising at least one of the foregoing metal oxides.

10. The multifunctional catalyst system of claim 1, wherein the first catalyst initiates or facilitates a reverse water gas shift reaction.

11. The multifunctional catalyst system of claim 1, wherein the second catalyst initiates or facilitates a Fischer-Tropsch reaction.

12. The multifunctional catalyst system of claim 10, wherein the first catalyst comprises lead oxide, copper oxide and/or zinc oxide disposed upon an alumina substrate.

13. The multifunctional catalyst system of claim 10, wherein the first catalyst comprises platinum disposed upon a ceria substrate.

14. The multifunctional catalyst system of claim 11, wherein the second catalyst comprises Group VIII metals disposed upon silica.

15. The multifunctional catalyst system of claim 14, wherein the Group VIII metals are iron, nickel, cobalt, or a combination comprising at least one of the foregoing metals.

16. The multifunctional catalyst system of claim 1, wherein the first catalyst and the second catalyst have an average inter-particle or average inter-domain spacings of about 10 to about 100 nanometers.

17. A process that employs the multifunctional catalyst system of claim 1.

18. The process of claim 17, wherein the process is a multistage process.

19. An article manufactured from the multifunctional catalyst system of claim 1.

20. A method comprising:
reducing carbon dioxide to carbon monoxide in a first reaction catalyzed by a first catalyst; and
reacting carbon monoxide with hydrogen in a second reaction catalyzed by second catalyst; wherein the first catalyst and the second catalyst are disposed upon a single substrate.

21. The method of claim 20, wherein the reacting of carbon monoxide with hydrogen produces an organic compound.

22. The method of claim 21, wherein the organic compound is an olefin or an oxygenate.

23. The method of claim 22, wherein the oxygenate is an alcohol.

24. The method of claim 20, wherein heat generated in the first reaction is utilized in the second reaction.

25. The method of claim 20, wherein the reducing carbon dioxide and the reacting carbon monoxide with hydrogen are both conducted at a temperature of about 180 to about 250° C.

26. An article manufactured by the method of claim 20.

27. A process comprising:
selectively functionalizing a substrate to form a functionalized substrate;
reacting a reverse water gas shift reaction catalyst to a first region of the functionalized substrate; and
reacting a Fischer-Tropsch catalyst to a second region of the functionalized substrate; wherein an average particle or domain spacing between particles or domains comprising the reverse water gas shift reaction catalyst or the Fischer-Tropsch catalyst is about 10 to about 1,000 nanometers.

28. The process of claim 27, further comprising impregnating the functionalized substrate with a first solution comprising a precursor to the reverse water gas shift reaction catalyst or with a first solution that comprises the reverse water gas shift reaction catalyst.

29. The process of claim 27, further comprising impregnating the functionalized substrate with a second solution comprising a precursor to the Fischer-Tropsch catalyst or with a second solution that comprises the Fischer-Tropsch catalyst.

30. The process of claim 28, further comprising converting the precursor to the reverse water gas shift reaction catalyst into a reverse water gas shift reaction catalyst.

31. The process of claim 29, further comprising converting the precursor to the Fischer-Tropsch catalyst into the Fischer-Tropsch catalyst.

32. A multifunctional catalyst system manufactured by the method of claim 27.

33. The process of claim 27, wherein the reverse water gas shift reaction catalyst comprises lead oxide, copper oxide and/or zinc oxide disposed upon an alumina substrate.

34. The process of claim 27, wherein the reverse water gas shift reaction catalyst comprises platinum disposed upon a ceria substrate.

35. The process of claim 27, wherein the reverse water gas shift reaction catalyst comprises gold particles disposed upon crystalline metal oxides.

36. The process of claim 35, wherein the metal oxides are iron oxide (Fe₂O₃), zirconia (ZrO₂), titania (TiO₂), zinc oxide (ZnO), or a combination comprising at least one of the foregoing metal oxides.

37. The process of claim 35, wherein the gold particles have an average particle size of less than or equal to about 10 nanometers.

38. The process of claim 27, wherein the reverse water gas shift reaction catalyst comprises copper and nickel disposed upon cerium oxide; and wherein the cerium oxide is stabilized with lanthanum.

39. The process of claim 38, wherein the copper and nickel are in nano-crystalline form and further wherein the copper and nickel are present in an amount of about 2 to about 8 wt %, based on the weight of the reverse water gas shift reaction catalyst.

40. The process of claim 27, wherein the Fischer-Tropsch catalyst comprises Group VIII metals disposed upon silica.

41. The process of claim 40, wherein the Group VIII metals are iron, nickel, cobalt, or a combination comprising at least one of the foregoing metals.

42. The multifunctional catalyst system of claim 1, wherein the first catalyst comprises gold particles disposed upon crystalline or semi-crystalline metal oxides.

43. The multifunctional catalyst system of claim 42, wherein the metal oxides are iron oxide (Fe₂O₃), zirconia (ZrO₂), titania (TiO₂), zinc oxide (ZnO), or a combination comprising at least one of the foregoing metal oxides.

44. The multifunctional catalyst system of claim 42, wherein the gold particles have an average particle size of less than or equal to about 10 nanometers.

45. The multifunctional catalyst system of claim 1, wherein the first catalyst comprises copper and nickel disposed upon cerium oxide; and wherein the cerium oxide is stabilized with lanthanum.

46. The multifunctional catalyst system of claim 45, wherein the copper and nickel are in nano-crystalline form and further wherein the copper and nickel are present in an amount of about 2 to about 8 wt %, based on the weight of the reverse water gas shift reaction catalyst.
